(19) United States
(12) Patent Application Publication
(10) Pub. No.: US 2016/0370450 A1
(43) Pub. Date: Dec. 22, 2016

(54) METHODS, DEVICES, AND COMPUTER PROGRAM PRODUCTS FOR DETERMINING RELATIVE DIRECTION OF REMOTE RF SIGNAL SOURCE

(71) Applicant: Sony Mobile Communications Inc., Tokyo (JP)

(72) Inventors: Ola Thorn, Lund (SE); Kare Agardh, Rydeback (SE); Erik Bengtsson, Mobilvagen (SE)

(21) Appl. No.: 14/746,002

(22) Filed: Jun. 22, 2015

(51) Int. Cl. G01S 3/46

(52) U.S. Cl. CPC G01S 3/46

(57) ABSTRACT

In a method of operating a wireless electronic device, a first angle-of-arrival is determined for a short-range wireless signal that is received at multiple antennas of the wireless electronic device from a signal source. Movement of the wireless electronic device is detected, and a second angle-of-arrival of a short-range wireless signal from the signal source is determined responsive to detecting the movement of the wireless electronic device. A relative direction of the signal source with respect to the wireless electronic device is identified based on an angular shift between the first angle-of-arrival and the second angle-of-arrival, relative to the movement of the wireless electronic device. Related wireless electronic devices and computer program products are also discussed.

### FIELD

The present disclosure generally relates to the field of wireless communications, and more particularly, to positioning technologies using wireless communications.

### BACKGROUND

Wireless technologies, such as Bluetooth® and/or Wi-Fi™, may allow for calculation of angle of arrival (AoA) and angle of departure (AoD), which may be useful for positioning technologies. For example, differences in time-of-arrival for radio frequency (RF) signals between two or more antennas may be used to calculate the angle-of-arrival of an RF signal, which can be used to estimate the approximate location of the source of the signal.

### SUMMARY

According to some embodiments, in a method of operating a wireless electronic device, a first angle (such as a first angle-of-arrival) is determined for a first wireless signal that is received at multiple antennas of the wireless electronic device from a signal source. Movement of the wireless electronic device is detected, and a second angle (such as a second angle-of-arrival) of a second wireless signal from the signal source that is received at the multiple antennas is determined. A relative direction of the signal source with respect to the wireless electronic device is identified based on an angular shift between the first angle and the second angle, relative to the movement of the wireless electronic device. The operations of determining the first angle, detecting the movement, determining the second angle, and identifying the relative direction are performed by at least one processor of the wireless electronic device.

In some embodiments, the first angle may be a first angle-of-arrival that is determined before the detecting of the movement, and the second angle may be a second angle-of-arrival that is determined after or responsive to the detecting of the movement. The movement may indicate a rotation of the wireless electronic device from the determining of the first angle-of-arrival to the determining of the second-angle-of arrival.

In some embodiments, the first and second wireless signals may be short-range wireless signals. The determining of the first and second angles-of arrival may be performed responsive to data received from an internal short-range wireless receiver of the wireless electronic device, and the detecting of the movement may be performed responsive to a signal received from an internal movement sensor of the wireless electronic device.

In some embodiments, the first angle-of-arrival may indicate different possible directions of the signal source relative to the wireless electronic device. One of the different possible directions may be identified as the relative direction of the signal source based on whether the angular shift between the first and second angles-of-arrival is opposite to the rotation of the wireless electronic device.

In some embodiments, further movement of the wireless electronic device toward the relative direction of the signal source may be detected responsive to the identifying, and an identification of the signal source may be provided responsive to the detecting the further movement theretoward.

In some embodiments, user instruction to orient the wireless electronic device toward the relative direction may be generated responsive to the identifying, and the further movement may be detected responsive to the generating of the user instruction.

In some embodiments, providing the identification of the signal source may include displaying a user interface for the signal source responsive to the detecting the further movement theretoward.

In some embodiments, the detecting of the further movement toward the relative direction of the signal source may be responsive to data received from the internal movement sensor, and may be independent of operation of the internal short-range wireless receiver.

In some embodiments, the signal source may be one of a plurality of signal sources from which respective short-range wireless signals are received at the multiple antennas of the wireless electronic device. Respective first angles-of arrival of the respective short-range wireless signals transmitted from the plurality of signal sources may be determined prior to the detecting the movement of the wireless electronic device, and respective second angles-of-arrival of the respective short-range wireless signals may be determined responsive to the movement of the wireless electronic device. Mapping data indicating the respective first and second angles-of-arrival and the movement of the wireless electronic device may be generated and stored in the wireless electronic device. The detecting the further movement may be based on the data received from the internal movement sensor and the mapping data.

In some embodiments, respective directions of one or more of the plurality of signal sources relative to the wireless electronic device may be identified based on the mapping data and independent of the operation of the internal short-range wireless receiver after generation of the mapping data.

In some embodiments, in providing the identification of the signal source, the signal source may be identified among the plurality of signal sources based on the relative direction in which the wireless electronic device is pointed.

In some embodiments, the determining of the respective second respective angles-of-arrival may be responsive to the movement of the wireless electronic device beyond a threshold. The threshold may be based on the respective first angles-of-arrival.

In some embodiments, an angle-of-arrival measurement function of the internal short-range wireless transceiver may be deactivated responsive to generating the mapping data. The angle-of-arrival measurement function of the internal short-range wireless transceiver may be reactivated responsive to detecting additional movement of the wireless electronic device beyond a range of the first and second angles-of-arrival indicated by the mapping data.

According to further embodiments of the present disclosure, a wireless electronic device includes at least one processor, a plurality of antennas, a wireless receiver coupled to the processor and the antennas, and a memory coupled to the processor. The memory includes computer readable program code stored therein which, when executed by the processor, causes the processor to determine a first angle (such as a first angle-of-arrival) of a first wireless signal transmitted from a signal source responsive to receiving the first wireless signal at the antennas of the wireless electronic device, detect movement of the wireless electronic device, and determine a second angle (such as a second angle-of-arrival) of a second wireless signal transmitted from the signal source responsive to receiving the second wireless signal at the antennas. The computer readable program code, when executed, further causes the processor to identify a relative direction of the signal source to the wireless electronic device based on an angular shift between the first angle and the second angle relative to the movement of the wireless electronic device.

According to still further embodiments of the present disclosure, a computer program product includes a non-transitory computer readable storage medium having computer readable program code embodied therein. The computer readable program code, when executed by at least one processor, causes the at least one processor to determine a first angle (such as a first angle-of-arrival) of a first wireless signal transmitted from a signal source responsive to receiving the first wireless signal at multiple antennas of the wireless electronic device, detect movement of the wireless electronic device, and determine a second angle (such as a second angle-of-arrival) of a second wireless signal transmitted from the signal source responsive to receiving the second wireless signal at the multiple antennas. The computer readable program code, when executed, further causes the processor to identify a relative direction of the signal source to the wireless electronic device based on an angular shift between the first angle and the second angle relative to the movement of the wireless electronic device.

Other methods, devices, and/or computer program products according to some embodiments will become apparent to one with skill in the art upon review of the following drawings and detailed description. It is intended that all such additional embodiments, in addition to any and all combinations of the above embodiments, be included within this description, be within the scope of the invention, and be protected by the accompanying claims.

### BRIEF DESCRIPTION OF THE DRAWINGS

The accompanying drawings, which are included to provide a further understanding of the invention and are incorporated in and constitute a part of this application, illustrate certain embodiment(s) of the invention. In the drawings:

FIGS. 1A and 1B are diagrams illustrating a wireless electronic device and methods of operation according to some embodiments of the present disclosure.

FIG. 2 is a block diagram illustrating a wireless electronic device according to some embodiments of the present disclosure.

FIG. 3 is a flowchart illustrating methods of operating a wireless electronic device according to some embodiments of the present disclosure.

FIGS. 4A-4E are block diagrams illustrating a wireless electronic device and methods of operation according to further embodiments of the present disclosure.

FIG. 5 is a flowchart illustrating methods of operating a wireless electronic device according to further embodiments of the present disclosure.

### DETAILED DESCRIPTION OF EMBODIMENTS

The present inventive concepts now will be described more fully with reference to the accompanying drawings, in which embodiments of the inventive concepts are shown. However, the present application should not be construed as limited to the embodiments set forth herein. Rather, these embodiments are provided so that this disclosure will be thorough and complete, and to fully convey the scope of the embodiments to those skilled in the art. Like reference numbers refer to like elements throughout.

The terminology used herein is for the purpose of describing particular embodiments only and is not intended to be limiting of the embodiments. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, steps, operations, elements, and/or components, but do not preclude the presence or addition of one or more other features, steps, operations, elements, components, and/or groups thereof.

It will be understood that when an element is referred to as being “coupled,” “connected,” or “responsive” to another element, it can be directly coupled, connected, or responsive to the other element, or intervening elements may also be present. In contrast, when an element is referred to as being “directly coupled,” “directly connected,” or “directly responsive” to another element, there are no intervening elements present. As used herein, the term “and/or” includes any and all combinations of one or more of the associated listed items.

Spatially relative terms, such as “above,” “below,” “upper,” “lower,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly. Well-known functions or constructions may not be described in detail for brevity and/or clarity.

It will be understood that, although the terms “first,” “second,” etc. may be used herein to describe various elements, these elements should not be limited by these terms. These terms are only used to distinguish one element from another. Thus, a first element could be termed a second element without departing from the teachings of the present embodiments.

Unless otherwise defined, all terms (including technical and scientific terms) used herein have the same meaning as commonly understood by one of ordinary skill in the art to which these embodiments belong. It will be further understood that terms, such as those defined in commonly-used dictionaries, should be interpreted as having a meaning that is consistent with their meaning in the context of the relevant art and will not be interpreted in an idealized or overly-formal sense unless expressly so defined herein.

As used herein, a “wireless electronic device” includes, but is not limited to, a device that is configured to receive/transmit long-range and/or short-range wireless communication signals via a wireless interface with, for example, a cellular network, a wireless local area network (WLAN), a satellite network, an AM/FM broadcast transmitter, and/or another electronic device. A wireless electronic device may thus include portable electronic devices, such as a mobile phone handset, wearable electronic devices, and/or other electronic devices that are discoverable and/or otherwise accessible via a wireless interface, such as a local-area or personal-area network interface, including wireless devices that communicate and/or may be otherwise interconnected in accordance with the Internet-of-Things (IoT). Short-range wireless signals can include Bluetooth®, Wi-Fi™, and/or other local-area or personal-area network communication signals, but exclude wide-area network, base-station, and/or satellite communication signals.

Portable wireless electronic devices, such as wearable wireless electronic devices, mobile phones, and tablets, may include a plurality of antennas. The antennas can be used to receive/measure signals to provide positioning information, such as navigation and location functions, which may be incorporated into some wireless technologies. In particular, some short-range communication technologies, such as Bluetooth® (BT) and Wireless Local Area Network (WLAN) technologies, may include angle-of-arrival and angle-of-departure functions. Example uses for angle-of-arrival and angle-of-departure capabilities may include indoor positioning/navigation (as satellite-based positioning may not work well indoors) and/or high-accuracy tracking. For instance, Wi-Fi™ and/or BT technologies may implement angle of arrival as a measure for positioning technologies. In principle, the distance from each of multiple antennas in a wireless electronic device to another electronic device or signal source is measured (for example, based on differences in the time of arrival (TDOA) of RF signals thereto), and with knowledge about the distance between the antennas in the wireless electronic device, the angle to the other electronic device (also referred to herein as the ‘remote’ device) can be determined.

One problem with some antenna-based positioning techniques that rely on measurement of path delay is that they may suffer from the presence of a ‘ghost’ image of the antenna of the remote device, at an equal but opposite angle with respect to the determined angle, if the two devices are placed along a line. Thus, such techniques may require the use of a third device/antenna to resolve the relative direction (or the relative position, which includes direction and distance) of the remote device with respect to the reference device. In other words, in some conventional positioning techniques, it may not be possible to distinguish whether the computed angle-of-arrival indicates a positive angle or a negative angle relative to the antennas, and thus, it may not be possible to distinguish the relative direction of the remote device with respect to the reference device (unless a third antenna/device is used). Another problem with using multiple antennas to identify the relative direction from one device to another is achieving acceptable resolution, for example, to distinguish between RF signals received from closely-positioned remote devices. The resolution can be affected by many factors, including but not limited to noise, number of antennas, separation between the antennas, RF bandwidth, etc.

Some embodiments of the present disclosure may arise from a realization that, by human nature, it is intuitive to point in a direction of an object upon which we wish to focus attention. For example, it is natural to point a remote control in the direction of a device over which control is desired. This may work effectively for a remote control that includes an infrared light transmitter, which functions based on directivity. In a radio transmitter, however, this directivity is lost. This loss of correlation between a device location and a direction in which a remote control is pointed may not be a significant issue when controlling a single device via radio transmitter, but may become problematic when one remote control is used to control multiple devices.

Accordingly, some embodiments of the present disclosure can locally determine relative direction or position of one device to another (without the use of a third device/antenna) by sensing a movement or rotation of a wireless electronic device, and comparing the change in angle of the wireless electronic device to a change of angle of a radio signal received from or transmitted to a signal source, in order to separate or distinguish the “true” direction or position of the remote signal source (relative to the wireless electronic device) from its ghost image. Further embodiments can increase resolution in angle measurement systems by using multiple measurements in combination with previously-determined relative position changes/movement based on data from one or more movement sensors (for example, an accelerometer or magnetometer) that may be included in the wireless electronic device. While embodiments described below are described with reference to two dimensional positioning or direction for ease of explanation, it will be understood that, by tracking the change in angle of the radio signal and the wireless electronic device orientation as described herein, positioning or direction in three dimensions can also be determined.

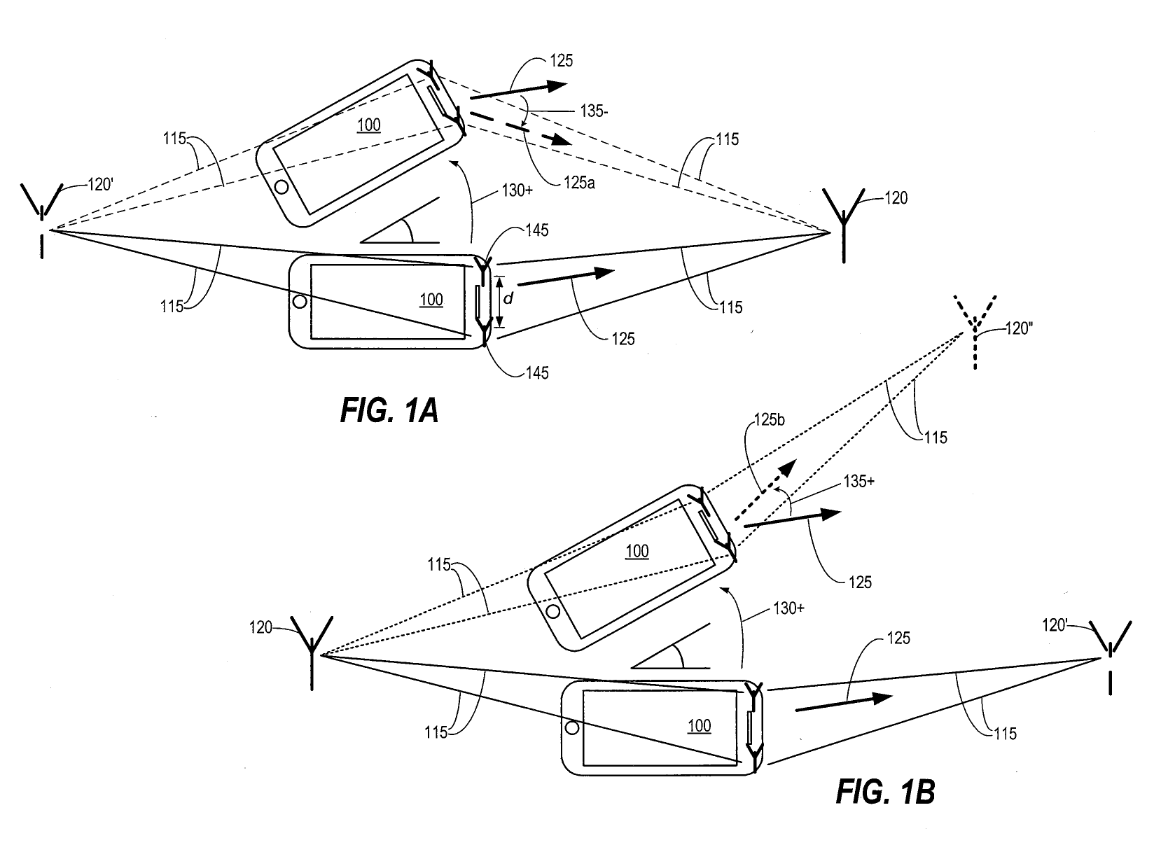

FIGS. 1A and 1B illustrate methods and devices for determining direction or position of a signal source relative to a wireless electronic device in accordance with some embodiments of the present disclosure. Referring now to FIGS. 1A and 1B, a wireless electronic device 100 (illustrated as a mobile telephone handset) includes two or more antennas 145 that receive one or more short-range wireless signals 115 from another, remote electronic device, more generally referred to herein as a signal source 120. Based on data received from its short-range wireless receiver, the wireless electronic device 100 is configured to determine a distance from each of the antennas 145 to the signal source 120 (for example, based on a time difference of arrival (TDOA) of the wireless signal 115 at the different antennas 145). In combination with the distance d between the antennas 145, the wireless electronic device 100 can calculate the angle-of-arrival 125 of the signal 115 at the wireless electronic device 100. However, the calculated angle-of-arrival 125 of the signal 115 can indicate at least two different possible directions or positions of the signal source 120 relative to the wireless electronic device 115, that is, based on the calculated angle 125 and its equal but opposite angle. Reference designators 120′ and 120″ thus indicate ‘ghost’ images of the signal source 120 at different possible directions or positions relative to the wireless electronic device 100, that is, at equal but opposite angles corresponding to the calculated angle of arrival.

Still referring to FIGS. 1A and 1B, the wireless electronic device 100 is configured to identify one of the different possible directions or positions 120, 120′, 120″ as the actual or “true” direction or position of the signal source 120 responsive to movement 130+ of the wireless electronic device 100, illustrated by way of example as rotational movement. In particular, responsive to the movement 130+ of the wireless electronic device 100, the angle-of-arrival 125 of the signal 115 will change differently (shown as 125a in FIG. 1A or 125b in FIG. 1B) depending on the relative direction or position of the signal source 120 with respect to the wireless electronic device 100, i.e., based on whether the signal source 120 is in front of the device 100 (i.e., to the right of the device 100 based on the device orientation shown in FIG. 1A) or behind the device 100 (i.e., to the left of the device 100 based on the device orientation shown in FIG. 1B). A movement sensor, such as an accelerometer or gyrometer (or, for horizontal movement, a compass or magnetometer) that is internal to the wireless electronic device 100 may be configured to detect or measure the movement of 130+ of the device 100. In the examples of FIGS. 1A and 1B, the movement 130+ is a rotational movement, which can occur when a user attempts to direct or orient the wireless electronic device 100 to point toward the signal source 120.

Based on whether or not the angular shift between the angles-of-arrival is opposite to the angular shift or rotation of the wireless electronic device 100, the wireless electronic device 100 is configured to identify one of the different possible directions as the relative direction of the signal source 120. In other words, by evaluating the change in angle of arrival 125 of the short-range wireless signal 115 relative to the detected movement 130+, the wireless electronic device 100 can determine if the signal source 120 is in front of or behind the wireless electronic device 100.

In particular, as shown in FIGS. 1A and 1B, the wireless electronic device 100 is configured to determine an initial (or “first”) angle-of-arrival 125 of the signal 115, detect the movement 130+, and then determine a subsequent (or “second”) angle-of-arrival 125a or 125b of the signal 115 after or responsive to the movement 130+. As shown in FIG. 1A, if a difference or change 135− between the first angle of arrival 125 and the second angle of arrival 125a is opposite to the direction of movement or rotation 130+ (e.g., the change in the angles-of-arrival 125, 125a defines a negative angular shift 135−, while the movement 130+ defines a positive angular shift), the wireless electronic device 100 determines that the signal source 120 is in front (here, to the right) of the wireless electronic device 100. On the other hand, as shown in FIG. 1B, if a difference or change 135+ between the first angle of arrival 125 and the second angle of arrival 125b is the same as or consistent with the direction of movement or rotation 130+ (e.g., the change in the angles-of-arrival 125, 125b defines a positive angular shift 135+, while the movement 130+ also defines a positive angular shift), the wireless electronic device 100 determines that the signal source 120 is behind (here, to the left of) the wireless electronic device 100.

In some embodiments, the signal source 120 itself may be mobile and/or in motion, thus creating changes in the angle-of-arrival independent of or in addition to the movement 130+ of the wireless electronic device 100. The wireless electronic device 100 may thus be configured to detect such movement of the signal source 120 (for example, based on the resulting changes in the angle-of-arrival of the short-range wireless signal 115 therefrom prior or subsequent to the movement 130+ of the device), and may perform determination of subsequent angles-of-arrival of the short-range wireless signal 115 responsive to detecting the movement of the signal source 120. In particular, as the movement 130+ (or lack thereof) of the device 100 itself is known, the wireless electronic device 100 can use this information to determine (or calculate) the relative direction or position of the signal source 120. Hence, while the angles-of-arrival 125a, 125b will change due to both the movement 130+ of the device 100 and the movement of the signal source 120, the changes due to the movement of the signal source 120 may be isolated based on the existing knowledge of the movement 130+ of the device 100 (for instance, by subtracting the changes in the angles-of-arrival 125a, 125b caused by the movement 130+ of the device 100), and thus, the relative direction or position of the moving signal source 120 may be identified.

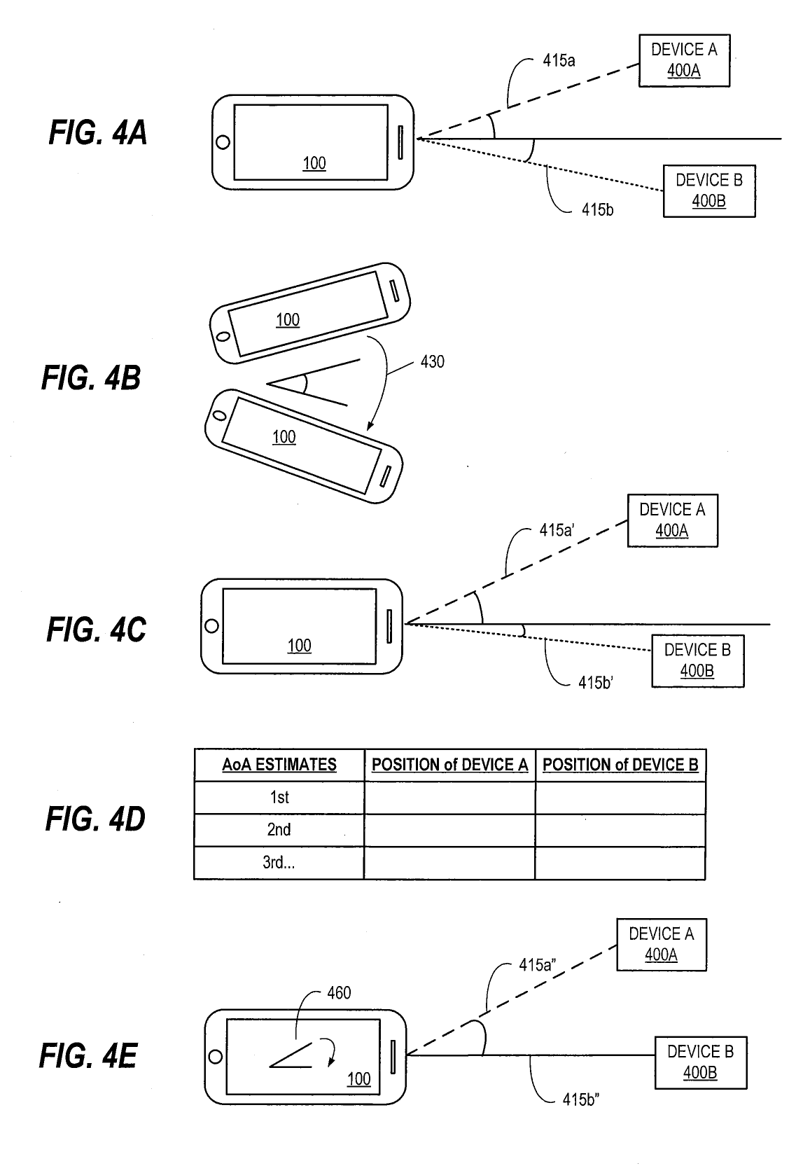

The wireless electronic device 100 may be further configured to perform a predefined action responsive to identifying the relative direction or position of the signal source 120. For example, based on the determined relative direction of the signal source 120, the wireless electronic device 100 may identify the signal source 120 (and/or other detected signal sources) and/or generate and display on-screen instructions as to how a user should move or orient the wireless electronic device 100 to point toward the signal source 120 (and/or other signal sources). Upon detecting that the wireless electronic device 100 is pointed or moved towards the signal source 120 (for example, via its internal movement sensor alone), the wireless electronic device 100 may selectively communicate with the signal source 120 and allow for control thereof, for example, by displaying a user interface for control over the signal source 120. As such, some embodiments of the present disclosure may use the determined relative direction or position to a signal source for selective communication with that particular signal source among other present or proximate signal sources, as discussed in greater detail below with reference to FIGS. 4A-4E.

Although shown in FIGS. 1A and 1B as including two antenna elements 145 by way of example, the wireless electronic device 100 can include more than two antenna elements in some embodiments. In addition, in the examples of FIGS. 1A and 1B, the movement 130+ is illustrated as a particular rotational movement; however, it will be understood that it may be possible to determine relative direction or position of the signal source 120 based on other rotational movements of the device 100 (for example, elevational rotation, axial rotation, etc.), and/or other movements of the device 100 (for example, lateral movement) in some embodiments. More generally, while illustrated herein with reference to particular elements or operations by way of example, it will be understood that embodiments of the present disclosure are not so limited.

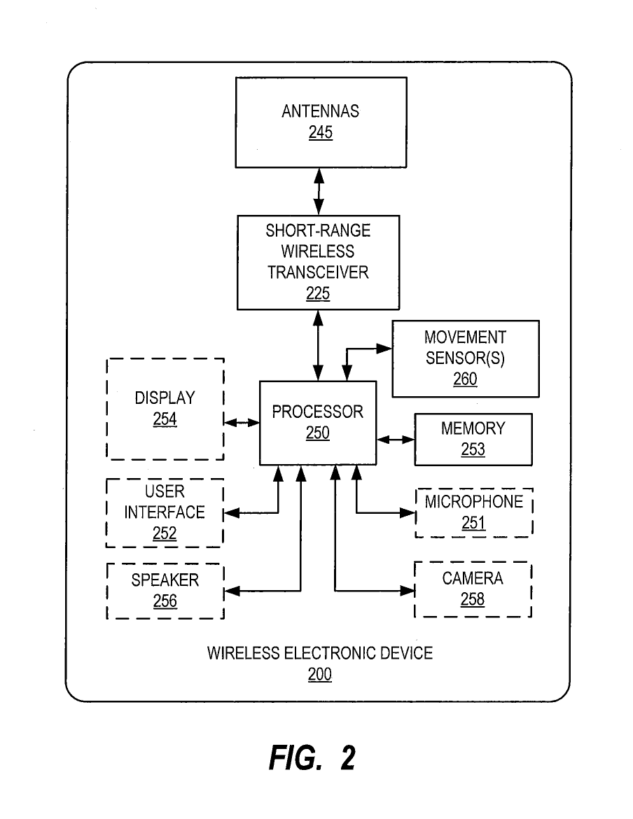

FIG. 2 is a block diagram illustrating a wireless electronic device 200 according to some embodiments of the present disclosure, such as the wireless electronic device 100 of FIGS. 1A-1B. As illustrated in FIG. 2, the wireless electronic device 200 includes a processor circuit 250, such as a microprocessor or microcontroller that is configured to control operations of the wireless electronic device 200, a memory 253, a short-range wireless transceiver 225, antennas 245, and one or more movement sensors 260 coupled to the processor 250. In particular, as discussed herein, the processor circuit 250 may be configured to calculate angles-of-arrival of a short-range wireless signal received via the antennas 245 and the short-range wireless transceiver 225 both before and after detection of movement of the wireless electronic device 200 by the movement sensor(s) 260, and may determine or identify a position or direction of a signal source of the short-range wireless signal relative to the wireless electronic device 200 based on an angular shift indicated by changes in the angles-of-arrival relative to the detected movement.

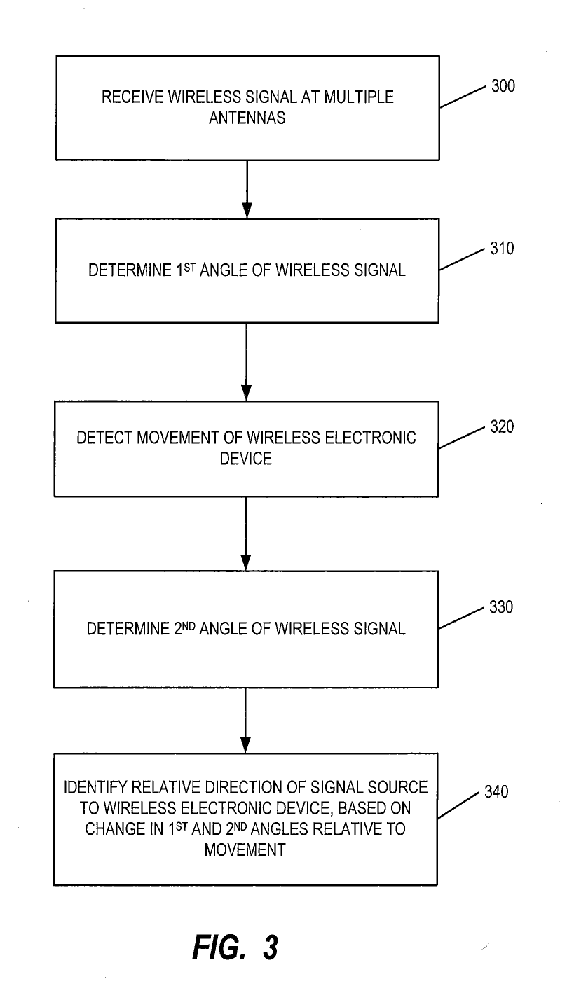

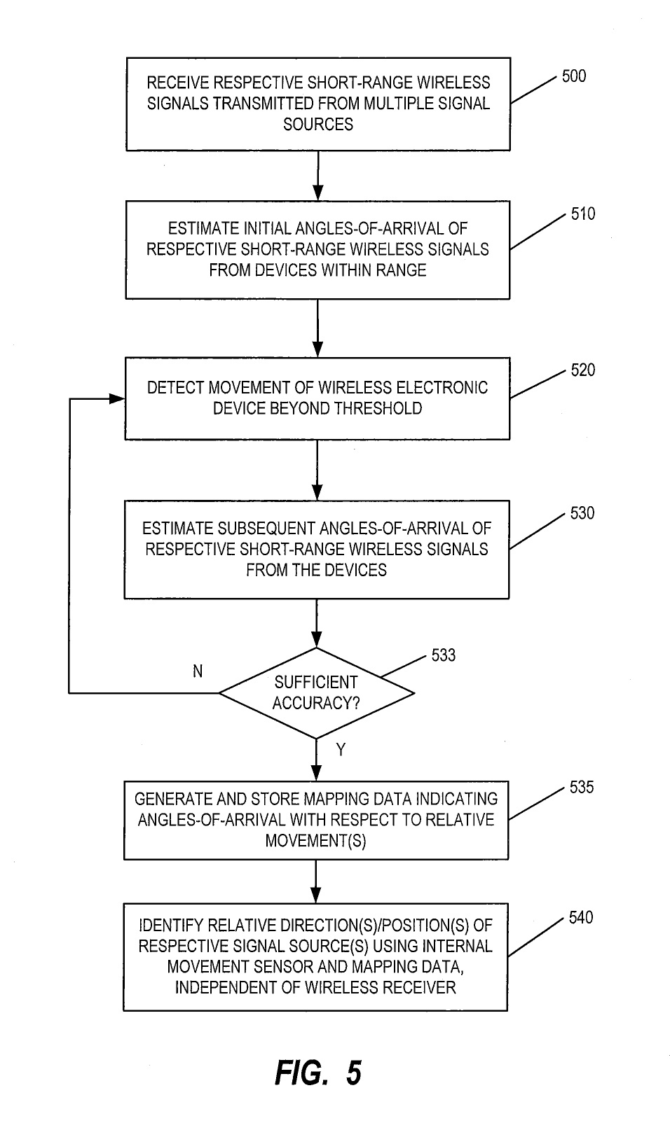

The memory 253 may be a general purpose memory that is used to store both program instructions for the processor 250 as well as data, such as audio data, video data, configuration data, and/or other data that may be accessed and/or used by the processor 250. The memory 253 may include a nonvolatile read/write memory, a read-only memory, and/or a volatile read/write memory. In particular, the memory 253 may include a read-only memory in which basic operating system instructions are stored, a non-volatile read/write memory in which re-usable data, such as configuration information, relative positioning measurement information, and other information may be stored, as well as a volatile read/write memory, in which short-term instructions and/or temporary data may be stored. As such, the memory 253 can store computer program instructions that, when executed by the processor circuit 250, carry out operations as described below with reference to the flowcharts included in FIGS. 3 and 5.

The short-range wireless transceiver 225 provides data or signals to the processor 250 that are indicative of or may otherwise be used to determine an angle-of-arrival of a received short-range wireless signal. The short-range wireless transceiver 225 may include one or more wireless transceiver circuits, such as a short-range radio transceiver circuit, coupled to the processor 250. The transceiver circuit(s) may include a transmitter circuit, a receiver circuit, and a modem, which cooperate to transmit and receive radio frequency signals to remote transceivers via the antennas 245. The short-range wireless transceiver 225 may include, for example, a Bluetooth® transceiver that allows the wireless communication device 200 to communicate with other Bluetooth® transceivers using a direct wireless interface. Additionally or alternatively, the short-range wireless transceiver 225 may include a WLAN transceiver that allows the wireless electronic device 200 to communicate through a WLAN router using a communication protocol that may include, but is not limited to, 802.11a, 802.11b, 802.11e, 802.11g, and/or 802.11i.

The device 200 can further include a switching circuit that is operable to provide separate communication paths for supplying/receiving RF signals to/from different ones of the antennas 245 via respective RF feeds. Also, in some embodiments, the wireless electronic device 200 may further include a cellular transceiver that allows the wireless communication device 200 to communicate using one or more cellular communication protocols such as, for example, Advanced Mobile Phone Service (AMPS), ANSI-136, Global Standard for Mobile (GSM) communication, General Packet Radio Service (GPRS), enhanced data rates for GSM evolution (EDGE), code division multiple access (CDMA), wideband-CDMA, CDMA2000, Universal Mobile Telecommunications System (UMTS), and 3GPP LTE (3rd Generation Partnership Project Long Term Evolution). More generally, although discussed in detail herein primarily with reference to short-range radio communications (e.g., Wi-Fi™, Bluetooth®, etc.), the device 200 may be configured to communicate using other over-the-air wireless communications (e.g., cellular wireless communications) in addition to the short-range radio communications.

Still referring to FIG. 2, the movement sensor(s) 260 are configured to detect movement and/or orientation of the wireless electronic device 200, for example, by providing data or signals indicative of the movement and/or orientation to the processor 250. The sensor(s) 260 may include one or more accelerometers, gyroscopes, magnetometers, and/or other sensors configured to detect movement/inertia (and/or orientation) of the wireless electronic device 200 independent of signals received via the antennas 245 and/or short-range wireless transceiver 225.

The wireless electronic device 200 may optionally include a display 254, a user interface 252, and/or a camera 258. For example, the wireless electronic device 200 may be a mobile telephone or a laptop/tablet computer including these components. Alternatively, if the wireless electronic device 200 is a wearable wireless electronic device, then one or more of the display 254, the user interface 252, and the camera 258 may be omitted. Moreover, in some embodiments, the wireless electronic device 100 may optionally include a speaker 256 and a microphone 251.

The wireless electronic device 200 is not limited to any particular combination/arrangement of the user interface 252 and the display 254. For example, the functions of the user interface 252 and the display 254 may be implemented by a touch screen through which a user can view information, such as computer-displayable files, provide input thereto, and otherwise control the wireless electronic device 200 and/or other devices, such as the signal source 120 of FIGS. 1A and 1B. Additionally or alternatively, the wireless electronic device 100 may include a separate user interface 252 and display 254. For example, user input may be accepted through a touchpad, a mouse, or another user input interface that is separate from the display 254 that provides graphical/visual outputs to the user.

Operation of the wireless electronic device 200 of FIG. 2 will now be described with reference to FIG. 3. FIG. 3 is a flowchart illustrating operations for identifying a relative direction or position of a wireless electronic device with respect to a remote device in accordance with some embodiments of the present disclosure. Referring now to FIG. 3, a short-range wireless signal that is transmitted from a signal source (such as the signal source 120 of FIGS. 1A-1B) is received at two or more of the antennas 245 of the wireless electronic device 200 at Block 300. An initial or first angle-of-arrival of the short-range wireless signal is determined by the processor 250 at Block 310. For example, responsive to receiving the short-range wireless signal at first and second ones of the antennas 245, the short-range wireless transceiver 225 may provide signals or data indicative of a time difference of arrival (TDOA) of the short-range wireless signal to the processor 250, and the processor 250 may calculate the first angle of arrival based on the signals from the transceiver 225 and a known distance between the antennas. The first angle-of-arrival, however, may be indicative of multiple possible directions or positions of the signal source relative to the wireless electronic device 200, e.g., one direction corresponding to the first angle-of-arrival, and another direction corresponding to its equal but opposite angle.

At Block 320, movement of the wireless electronic device is detected, for example, via the internal movement sensor(s) 260. The movement may indicate an angular shift or rotation of the wireless electronic device 200 relative to its initial orientation during determination of the first angle-of-arrival at Block 310. Responsive to detecting the movement at Block 320, a subsequent or second angle-of-arrival of a same or different short-range wireless signal from the signal source is determined by the processor 250 at Block 330. The second angle-of-arrival may likewise be indicative of multiple possible directions or positions of the signal source relative to the wireless electronic device 200.

Still referring to FIG. 3, the actual or “true” relative direction or position of the signal source with respect to the wireless electronic device 200 is identified by the processor 250 at Block 340, based on an angular shift between the first and second angles-of-arrival relative to the movement of the wireless device 200 detected at Block 320. In particular, when the angular shift between the first and second angles-of-arrival is opposite to the angular shift indicated by the rotational movement of the wireless electronic device 200 (e.g., one angular shift is positive and the other is negative, as shown for example in FIG. 1A), it is determined by the processor 250 that the signal source is in front of the wireless electronic device 200. On the other hand, when the angular shift between the first and second angles-of-arrival changes in a same manner as the angular shift indicated by the rotational movement of the wireless electronic device 200 (e.g., both angular shifts are positive or negative, as shown for example in FIG. 1B), it is determined by the processor 250 that the signal source is behind the wireless electronic device 200.

Thus, by evaluating the change or angular shift between the initial and subsequent angles-of-arrival of the short-range wireless signal as compared to the change in movement or angular shift of the wireless electronic device 200, the processor 250 is configured to distinguish the actual direction or position of the signal source from its ‘ghost’ image, and thus, identify the direction or position of the signal source relative to the wireless electronic device. Example applications of such identification of relative position and/or direction include selectively connecting or communicating with one of a plurality of proximately-located signal sources, as further described below.

FIGS. 4A-4E are schematic diagrams illustrating operations for increasing resolution by using sensor data in combination with multiple measurements in accordance with some embodiments of the present disclosure. In particular, FIGS. 4A-4E illustrate an example use case for the wireless electronic device 100 of FIG. 1, using the determined relative direction to implement “point-and-click” control over another device, i.e., to identify and address a specific device among multiple signal sources responsive to detecting that the wireless electronic device 100 is oriented or pointed toward the specific device (based on the determined relative direction thereof). In such a use case, it may be natural for the wireless electronic device 100 to moved or oriented to point in a direction toward the remote device. This movement can be used as an advantage in order to increase the positioning resolution.

Referring now to FIG. 4A, the wireless electronic device 100 receives respective short-range wireless signals from multiple signal sources (illustrated with reference to Device A 400A and Device B 400B), which are closely located. For example, Device A 400A and Device B 400B may be home multimedia devices that are located in close proximity to one another, for instance, stacked in a home entertainment center or rack, making it difficult to distinguish toward which of the devices 400A, 400B the wireless electronic device 100 is pointed. In accordance with some embodiments of the present disclosure, to distinguish between the multiple remote devices 400A, 400B with improved accuracy, the wireless electronic device 100 performs an initial angle-of-arrival measurement based on the respective short-range wireless signals 415a, 415b received from the devices 400A, 400B. The initial angle-of-arrival measurements indicate the relative directions or positions of the devices 400A, 400B with respect to the wireless electronic device 100, and are also time-stamped and associated with a current position and/or orientation of the wireless electronic device 100, for example, as detected by an internal movement sensor.

As shown in FIG. 4B, the relative physical movement of the wireless electronic device 100 is also monitored, for example, by the internal movement sensor. When movement 430 of the device 100 above a threshold is detected, the wireless electronic device 100 performs a subsequent angle-of-arrival measurement based on the respective short-range wireless signals 415a′, 415b′ received from the devices 400A, 400B at the new position and/or orientation of the device 100, as shown in FIG. 4C. The subsequent angle-of-arrival measurements thus indicate the relative directions or positions of the devices 400A, 400B with respect to the wireless electronic device 100 based on the angular shift with respect to the initial angle-of-arrival measurements relative to the detected movement 430, and are likewise time-stamped and associated with a current position and/or orientation of the wireless electronic device 100. In some embodiments, the movement 430 may be a rotational movement that shifts the angle of orientation of the wireless electronic device 100 relative to the devices 400A, 400B, and the threshold may be based on a movement 430 that is sufficient to change the initial angles of arrival by more than a predetermined angular shift.

The initial and subsequent angle-of-arrival measurements captured in FIGS. 4A and 4C can thus be combined with the detected movement in FIG. 4B to generate and store a table or mapping of device position versus angle-of-arrival (AoA) estimates, as shown in FIG. 4D. The table of stored data thus provides a two- or three-dimensional representation of the relative position or direction for each of the multiple signal sources 400A, 400B based on the changes in the respective angles-of-arrival relative to the detected device movement 430, for the present location of the wireless electronic device 100. The operations shown in FIGS. 4A-4D can be iterated until the table includes a sufficient number of AoA estimates and associated positions of the wireless electronic device 100 to distinguish between the devices 400A, 400B with a desired accuracy.

As shown in FIG. 4E, by accessing the stored mapping data generated in FIG. 4D, the internal movement sensor of the wireless electronic device 100 can be used on its own (that is, independent of other signals indicating relative directions or positions, such as those received from the short-range wireless transceiver) to determine toward which of the devices 400A, 400B the wireless electronic device 100 is oriented or pointed. For example, when the wireless electronic device 100 determines that it is pointed at Device B 400B, an identification of Device B 400B and/or a user interface for control of Device B 400B may be displayed by the wireless electronic device 100. That is, the wireless electronic device 100 may selectively display an interface specific to the device to which it is aimed, among other proximate devices. Additionally, user instruction 460 as to how to orient the wireless electronic device 100 toward the relative direction of one or more of the devices 400A, 400B may be displayed by the wireless electronic device 100 based on its current position and/orientation (as indicated by the internal movement sensor) and the stored mapping data. For example, FIG. 4E illustrates a user instruction 460 indicating a direction in which a user should rotate the wireless electronic device 100 (and/or an associated amount of rotation) in order for the wireless electronic device 100 to point toward Device B 400B. As such, the angle sensor functionality (e.g., the measurement and/or calculation function of the short-range wireless transceiver) can be deactivated until the wireless electronic device 100 is moved beyond the area covered by the initial and subsequent AoA measurements. If further movement of the wireless electronic device 100 beyond the accuracy covered by the table for position vs. AoA is detected, the angle sensor functionality can be reactivated to perform a subsequent angle-of-arrival measurement based on the respective short-range wireless signals 415a″, 415b″ received from the devices 400A, 400B at the new position and/or orientation of the device 100.

Operation of the wireless electronic device 100 of FIGS. 4A-4E will now be described in greater detail with reference to FIG. 5. In particular, FIG. 5 is a flowchart illustrating operations for identifying relative directions or positions between a wireless electronic device and a plurality of remote devices in accordance with some embodiments of the present disclosure.

Referring now to FIG. 5, respective short-range wireless signals transmitted from multiple signal sources 400A, 400B are received at an antenna array of a wireless electronic device 100 at Block 500. Respective initial (or “first”) angles-of arrival of the respective short-range wireless signals are estimated or computed at Block 510. The initial angles-of-arrival may indicate more than one possible direction or position of the each of the signal sources 400A, 400B relative to the wireless electronic device 100.

Subsequent movement of the wireless electronic device 100 beyond a predetermined threshold amount is detected at Block 520. The threshold may be based, for example, on movement of the device 100 that is sufficient to change the initial angles of arrival by more than a predetermined angular shift, which may be based on a desired resolution or accuracy. In some embodiments, the threshold may vary based on current conditions and/or device configuration, for example, based on current noise conditions, the number of antennas currently in use by the wireless electronic device 100 to receive the short-range wireless signals, the distance or separation between the antennas in-use, and/or the available bandwidth. Also, the movement may be detected at Block 520 using a movement sensor that is internal to the wireless electronic device 100, such as the movement sensor 260 that is internal to the device 200 of FIG. 2. The movement sensor may be, for example, an accelerometer or compass that calculates movement of the wireless electronic device independent of signals received from an external signal source, such as the signal sources 400A, 400B.

Respective subsequent (or “second”) angles-of-arrival of the respective short-range wireless signals transmitted from the signal sources 400A, 400B are thus estimated at Block 530, responsive to detection of the movement of the wireless electronic device at Block 520. In some embodiments, respective angular shifts between the initial and subsequent angles-of-arrival can be used to identify respective directions or positions of one or more of the signal sources 400A, 400B relative to the wireless electronic device 100 at its position or orientation resulting from the movement at block 520, as discussed above.

At Block 533, it is determined by the wireless electronic device 100 whether the estimates of the initial and subsequent angles-of-arrival (computed at Blocks 510 and 530, respectively), in combination with the detected movement (detected at Block 520) provide a level of accuracy that is sufficient to distinguish between the relative directions or positions of the signal sources 400A and 400B, based on the angle-of-arrival estimates relative to the detected movement. If not, operations return to Block 520 such that additional movement(s) of the wireless electronic device 100 are detected, and additional subsequent angles-of-arrival of the respective short-range wireless signals transmitted from the signal sources 400A, 400B are estimated at Block 530.

If it is determined at Block 533 that the initial and subsequent angles-of-arrival (computed at Blocks 510 and 530, respectively), in combination with the detected movement (detected at Block 520) provide a sufficient level of accuracy to distinguish between the relative directions or positions of the signal sources 400A and 400B, mapping data indicating the initial and subsequent angles-of-arrival corresponding to each of the detected movement(s) of the wireless electronic device 100 is generated and stored at Block 535. For example, the mapping data may be stored in a table as shown in FIG. 4D. The stored mapping data thus provides a spatial reference indicating the relative directions or positions of each of the multiple signal sources 400A, 400B based on the respective angles-of-arrival determined at Blocks 510 and 530, for respective positions or orientations of the wireless electronic device 100.

As such, at Block 540, the respective directions or positions of one or more of the signal sources 400A and 400B relative to the wireless electronic device 100 are identified using the internal movement sensor and the stored mapping data, and independent of data provided by the wireless short-range transceiver. In particular, based on the current position and/or orientation of the device 100 indicated by the movement sensor, the stored mapping data corresponding to the indicated position/orientation is accessed, and based on the associated angles-of-arrival of the respective short-range wireless signals from the signal sources 400A, 400B stored therein, the relative directions or positions of one or more of the signal sources 400A, 400B for the current position/orientation of the wireless electronic device 100 are identified. Accordingly, in response to generating the mapping data at Block 535, the identification of the relative position(s)/direction(s) of the signal sources 400A, 400B can be determined using the internal movement sensor alone, and thus, one or more functions of the wireless transceiver (such as the angle-of-arrival measurement function) can be deactivated, for example, to improve battery life of the device 100.

Embodiments of the present disclosure may be used in the context of peer-to-peer (P2P) positioning between two wireless electronic devices. For example, the antennas may be included in a smartphone located near one or more Bluetooth®-compatible wearable electronic devices, and may use signals received from the wearable device(s) to determine the direction(s) or position(s) of the wearable device(s) relative to the smartphone, so that the user of the smartphone may locate the wearable electronic device(s) when lost or misplaced. In another example, the antennas may be included in a smartphone located near (and receiving signals from) a plurality of multimedia devices that are closely located, for example, in a home entertainment center or home office, and, based on the respective signals received from the multimedia devices, may be used to direct a user to orient the smartphone to point toward (and allow control over) a desired one of the multimedia devices.

Although described herein with reference to determining first and second angles-of-arrival before and after detection of movement of the wireless electronic device, it will be understood that the angles-of-arrival can be continuously measured, and that the movement of the wireless electronic device can be used to initiate identification of relative direction or position of the signal source and/or the ghost images. As the angles-of-arrival may be continuously measured, only the actual angle-of-arrival may be tracked, and occasionally the movement information may be used to ensure or verify the relative direction or position of the signal source and/or to otherwise cancel further ghost images for three-dimensional positioning. As such, it will be understood that embodiments of the present disclosure may also include scenarios where a position of one or more signal sources is logged as mapping data, rather than evaluating relative direction or position only responsive to pointing the wireless electronic device at a signal source.

The flowcharts shown in FIGS. 3 and 5 illustrate the architecture, functionality, and operations of embodiments of hardware and/or software according to various embodiments of the present invention. It will be understood that each block of the flowchart and/or block diagram illustrations, and combinations of blocks in the flowchart and/or block diagram illustrations, may be implemented by computer program instructions and/or hardware operations. In this regard, each block represents a module, segment, or portion of code, which comprises one or more executable instructions for implementing the specified logical function(s). It should be noted that, in other implementations, the function(s) noted in the blocks may occur out of the order noted in the Figures. For example, two blocks shown in succession may, in fact, be executed substantially concurrently, or the blocks may sometimes be executed in the reverse order, depending on the functionality involved.

The computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks. The computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of all combinations and subcombinations of the embodiments described herein, and of the manner and process of making and using them, and shall support claims to any such combination or subcombination.

In the drawings and specification, there have been disclosed various embodiments and, although specific terms are employed, they are used in a generic and descriptive sense only and not for purposes of limitation, the scope of the inventive concepts being set forth in the following claims.

That which is claimed:

1. A method of operating a wireless electronic device, the method comprising:
performing operations as follows by at least one processor of the wireless electronic device:
determining a first angle of a first wireless signal transmitted from a signal source, wherein the first wireless signal is received at multiple antennas of the wireless electronic device;
detecting movement of the wireless electronic device;
determining a second angle of a second wireless signal transmitted from the signal source, wherein the second wireless signal is received at the multiple antennas; and
identifying a relative direction of the signal source to the wireless electronic device based on an angular shift between the first angle and the second angle relative to the movement of the wireless electronic device.

2. The method of claim 1, wherein:
the first angle comprises a first angle-of-arrival that is determined before the detecting of the movement;
the second angle comprises a second angle-of-arrival that is determined after the detecting of the movement; and
the movement indicates a rotation of the wireless electronic device from the determining of the first angle-of-arrival to the determining of the second-angle-of arrival.

3. The method of claim 2, wherein the first angle-of-arrival indicates different possible directions of the signal source relative to the wireless electronic device, and wherein identifying the relative direction comprises:
identifying one of the different possible directions as the relative direction of the signal source based on whether the angular shift between the first and second angles-of-arrival is opposite to the rotation of the wireless electronic device.

4. The method of claim 3, wherein the first and second wireless signals comprise short-range wireless signals, and further comprising:
detecting further movement of the wireless electronic device toward the relative direction of the signal source responsive to the identifying; and
providing an identification of the signal source responsive to the detecting the further movement theretoward.

5. The method of claim 4, further comprising:
generating user instruction to orient the wireless electronic device toward the relative direction responsive to the identifying of the relative direction, wherein the detecting the further movement is responsive to the generating the user instruction.

6. The method of claim 4, wherein providing the identification comprises:
displaying a user interface for the signal source responsive to the detecting the further movement theretoward.

7. The method of claim 4, wherein the detecting the further movement toward the relative direction of the signal source is responsive to data received from a movement sensor that is internal to the wireless electronic device, and is independent of operation of a short-range wireless receiver thereof.

8. The method of claim 7, wherein the signal source comprises one of a plurality of signal sources from which respective short-range wireless signals are received at the multiple antennas of the wireless electronic device, and further comprising:
determining respective first angles-of arrival of the respective short-range wireless signals transmitted from the plurality of signal sources prior to the detecting the movement of the wireless electronic device;
determining respective second angles-of-arrival of the respective short-range wireless signals responsive to the detecting the movement of the wireless electronic device; and
generating mapping data indicating the respective first and second angles-of-arrival and the movement of the wireless electronic device;
wherein the detecting the further movement is based on the data received from the movement sensor and the mapping data.

9. The method of claim 8, wherein the identifying comprises identifying respective directions of one or more of the signal sources relative to the wireless electronic device based on the mapping data and independent of the operation of the short-range wireless receiver after generation of the mapping data.

10. The method of claim 8, wherein the determining the respective second angles-of-arrival is responsive to the movement of the wireless electronic device beyond a threshold that is based on the respective first angles-of-arrival.

11. The method of claim 8, further comprising:
deactivating an angle-of-arrival measurement function of the short-range wireless receiver responsive to generating the mapping data; and
reactivating the angle-of-arrival measurement function of the short-range wireless receiver responsive to detecting that the wireless electronic device has moved beyond a range indicated by the mapping data.

12. A wireless electronic device, comprising:
at least one processor;
a plurality of antennas;
a wireless receiver coupled to the processor and the antennas; and
a memory coupled to the processor, the memory comprising computer readable program code stored therein that, when executed by the processor, causes the processor to:
determine a first angle of a first wireless signal transmitted from a signal source, responsive to receiving the first wireless signal at the antennas thereof;
detect movement of the wireless electronic device;
determine a second angle of a second wireless signal transmitted from the signal source, responsive to receiving the second wireless signal at the antennas; and
identify a relative direction of the signal source to the wireless electronic device based on an angular shift between the first angle and the second angle relative to the movement of the wireless electronic device.

13. The wireless electronic device of claim 12, wherein:
the first angle comprises a first angle-of-arrival that is determined before detection of the movement;
the second angle comprises a second angle-of-arrival that is determined after the detection of the movement; and
the movement indicates a rotation of the wireless electronic device from the first angle-of-arrival to the second-angle-of arrival.

14. The wireless electronic device of claim 13, wherein the first angle-of-arrival indicates different possible directions of the signal source relative to the wireless electronic device, and wherein, to identify the relative direction, the computer readable program code causes the processor to:
identify one of the different possible directions as the relative direction of the signal source based on whether the angular shift between the first and second angles-of-arrival is opposite to the rotation of the wireless electronic device.

15. The wireless electronic device of claim 14, wherein the first and second wireless signals transmitted from the signal source comprise short-range wireless signals, and further comprising computer readable program code stored in the memory that, when executed by the processor, causes the processor to:
detect further movement of the wireless electronic device toward the relative direction of the signal source responsive to identification of the relative direction; and
provide an identification of the signal source responsive to detection of the further movement theretoward.

16. The wireless electronic device of claim 15, further comprising computer readable program code stored in the memory that, when executed by the processor, causes the processor to:
generate user instruction to orient the wireless electronic device toward the relative direction responsive to identification of the relative direction, wherein the detection of the further movement is responsive to the generating the user instruction.

17. The wireless electronic device of claim 15, wherein, to provide the identification of the signal source, the computer readable program code causes the processor to:
display a user interface for the signal source responsive to the detection of the further movement theretoward.

18. The wireless electronic device of claim 15, further comprising:
a movement sensor that is internal to the wireless electronic device and is coupled to the processor,
wherein the detection of the further movement toward the relative direction of the signal source is responsive to data received from the movement sensor, and is independent of operation of the wireless receiver.

19. The wireless electronic device of claim 18, wherein the signal source comprises one of a plurality of signal sources from which respective short-range wireless signals are received at the antennas of the wireless electronic device, and further comprising computer readable program code stored in the memory that, when executed by the processor, causes the processor to:
determine respective first angles-of arrival of the respective short-range wireless signals transmitted from the plurality of signal sources prior to detection of the movement of the wireless electronic device;
determine respective second angles-of-arrival of the respective short-range wireless signals responsive to the detection of the movement of the wireless electronic device; and
generate mapping data indicating the respective first and second angles-of-arrival and the movement of the wireless electronic device;
wherein the detection of the further movement is based on the data received from the movement sensor and the mapping data.

20. A computer program product, comprising:
a non-transitory computer readable storage medium having computer readable program code embodied therein that, when executed by at least one processor, causes the processor to:
determine a first angle of a first wireless signal transmitted from a signal source, responsive to receiving the first wireless signal at multiple antennas of the wireless electronic device;
detect movement of the wireless electronic device;
determine a second angle of a second wireless signal transmitted from the signal source, responsive to receiving the second wireless signal at the multiple antennas; and
identify a relative direction of the signal source to the wireless electronic device based on an angular shift between the first angle and the second angle relative to the movement of the wireless electronic device.
